(19) United States
(12) Patent Application Publication
(10) Pub. No.: US 2005/0217933 A1
(43) Pub. Date: Oct. 6, 2005

(54) Sound absorbing material for a vehicle

(76) Inventors: Shim Sung Young, Ulsan (KR); Chung Kil Jung, Hwaseong-si (KR)

Correspondence Address: MORGAN, LEWIS & BOCKIUS LLP (SF), 2 PALO ALTO SQUARE, PALO ALTO, CA, 94306, US

(21) Appl. No.: 11/028,134

(22) Filed: Dec. 30, 2004

(30) Foreign Application Priority Data
Dec. 31, 2003 (KR) 10-2003-0101955
Nov. 4, 2004 (KR) 10-2004-0089345

(51) Int. Cl. B64F 1/26; G10K 11/00; E04B 1/82; E04H 17/00; E04B 2/02

(52) U.S. Cl. 181/290; 181/286; 181/210

(57) ABSTRACT

A sound absorbing material for a vehicle comprising at least two layers of one with a high surface density layer and the other with a low surface density layer, wherein the high density layer is intensively positioned at the portion greatly improving the noise problem of a vehicle. Advantages include a capability of recycling, improving sound-absorbing performance and reducing weight.

### CROSS-REFERENCE TO RELATED APPLICATIONS

This application claims priority of Korean Application No. 10-2003-0101955, filed Dec. 31, 2003 and Korean Application No. 10-2004-0089345, filed Nov. 4, 2004, the disclosures of which are incorporated herein by reference in their entirety.

### BACKGROUND OF THE INVENTION

1. Field of the Invention

The present invention relates to a sound absorbing material for a vehicle and more particularly, a sound absorbing material including a high density layer positioned to improve the noise problem of a vehicle.

2. Description of the Related Art

The typical noise introduced into the inside of a vehicle is generated at the engine of the vehicle and transmitted via air or the body of the vehicle. An engine cover, a hood insulator, etc. are generally used to reduce this noise, however, the noise-reducing effect by the above parts is not great, and in fact, a dash outer component equipped outside of a vehicle or a dash inner component equipped inside of a vehicle serves to remove most of the noise.

To prevent the noise inflow into a vehicle, a sound absorbing material prepared by bonding or thermally fusing polyurethane (PU) foam or polyethylene terephtalate (PET) on a sound insulating layer (heavy sound insulating sheet), which is called a heavy layer, has been attached to dash panel, for a dash inner component. This can increase the sound insulating effect, but it is disadvantageous in that it results in increase in the weight of the assembly (about 6-9 kg each), increase in the production cost and has difficulty in recycling. Further, because the sound insulating material is installed inside a vehicle, it contributes little to remove the noise generated inside the vehicle. Also, a method of attaching a sound absorbing and insulating material prepared by attaching additional heavy-layer sound insulating material to a sound absorbing material having a double-layered structure of high density material and low density material to dash panel has been introduced. In this case, improvement in weight reduction and sound absorption is not sufficient. In addition, the bad odor of the heavy-layer material produces another problem to be resolved.

As an alternative, a material prepared by crushing fiber scrap and adding a binder fiber is attempted. In this case, the sound absorbing performance varies greatly because of difficulty in fiber scrap control. Further, the processing becomes difficult and cost becomes increased due to dust generation. In addition, the bad odor is generated when the material is used for a long period of time. Recently, methods of reducing weight by replacing the heavy sound insulating layer with a thermally bonded nonwoven layer of a binder fiber having a relatively low melting point, such as polyolefin and polyester, and a synthetic fiber having a high melting point to differentiate the density or air flow rate have been proposed [Japan Patent Publication No. Hei 8-152890, Japan Patent Publication No. Hei 11-180224, Japan Patent Publication No. Hei 6-247202, Japan Patent Publication No. Hei 6-259080, Japan Patent Publication No. Hei 8-108500, Japan Patent Publication No. Hei 10-247085, Korea Patent Publication No. 2003-0000746, etc.] However, these methods were only partially effective in reducing weight, and they were not as effective as that of the present invention.

In general, a sound absorbing material to which a heavy layer sound insulating sheet is attached and a sound absorbing material comprising a fiber material differ in their sound transfer mechanism. In the conventional sound absorbing material to which a heavy layer sound insulating sheet is attached, the noise generated in the engine passes through dash panel of a vehicle. Then, it is reflected at crash pad inside the vehicle and transferred to heavy layer sound insulating sheet. Lastly, the noise reflected at sound insulating sheet is transferred inside of the vehicle. Because no sound absorbing mechanism exists between sound insulating sheet and crash pad, high-frequency sound is reflected directly to inside of the vehicle. Frequency analysis of the noise shows that it is mostly loud high-frequency sound of 1,000 Hz or higher.

It should be noted that only about 50% of dash inners have a thickness of at least 15 mm. Therefore, noise from air conditioner pipes or leakage noise through brake booster holes are transferred to inside of a vehicle without being absorbed.

Analysis on sound pressure distribution of the noise from the engine when it contacts the dash panel shows that the sound pressure is highest at the center and is gradually declined as it goes toward the outside. That is, noise improvement effect of the sound absorbing material of a dash inner is highest near the engine and decreases as the distance from the engine increases. Consequently, it is unnecessary to make the structure of the sound absorbing material identical at all locations. However, conventionally, sound absorbing materials having equal structure are used at all positions. Therefore, it is not advantageous in reducing weight or improving processability. To take a multi-layer sound absorbing material comprising fiber materials having equal area of high surface density layer and low surface density layer as example, the surface becomes too hard after the high density sound absorbing material layer is formed. Therefore, problems such as mobility of the dash inner sound absorbing material and defoaming at the dash panel occur frequently.

### SUMMARY OF THE INVENTION

The present invention relates to a sound absorbing material for a vehicle in which a low density sound absorbing material having a relatively low surface density and a high density sound absorbing material having a relatively high surface density are laminated in at least two layers.

Embodiments of the present invention provide a sound absorbing material for a vehicle comprising at least two layers of one with a high surface density layer and the other with a low surface density layer, wherein the high density layer is positioned at the portion greatly improving the noise problem of a vehicle. The present invention is advantageous in that it is capable of recycling, improving sound-absorbing performance and reducing weight, compared with the conventional heavy layer structure.

At the portion requiring superior vibration control and low frequency sound absorbing and improving performance, the high density sound absorbing material is laminated. At other portions, only the low density sound absorbing material is used to form a single-layered structure.

Especially, the high density sound absorbing material is laminated at the center of the sound absorbing material opposing the center of a dash panel.

A nonwoven fabric may be inserted between the high density sound absorbing material and the low density sound absorbing material.

The high density sound absorbing material comprises a sound absorbing material having a surface density of 500-2,000 g/m² and the low density sound absorbing material comprises a sound absorbing material having a surface density of 500-2,000 g/m².

The lamination area of the high density sound absorbing material comprises 20-90% of the area of the low density sound absorbing material.

Preferably, the lamination area of the high density sound absorbing material comprises 30-80% of the area of the low density sound absorbing material.

More preferably, the lamination area of the high density sound absorbing material comprises 40-60% of the area of the low density sound absorbing material.

### BRIEF DESCRIPTION OF THE DRAWINGS

The aforementioned aspects and other features of the present invention will be explained in the following description, taken in conjunction with the accompanying drawings, wherein:

FIG. 1 is a cross-sectional view of the double-layered sound absorbing material of the present invention;

FIG. 2a shows the center portion of a dash panel requiring vibration control and low frequency absorption and insulation;

FIG. 2b shows the double-layered portion and the single-layered portion of the double-layered sound absorbing material of the present invention;

FIG. 3 is a schematic diagram showing the noise transfer mechanism of the present invention; and

FIG. 4a and FIG. 4b show sound absorbing and insulating performance of the sound absorbing material of the present invention and the conventional heavy layer sound insulating sheet.

### DETAILED DESCRIPTION OF PREFERRED EMBODIMENTS

Hereinafter, the present invention is described in more detail referring to the drawings.

The present invention relates to a sound absorbing material for a vehicle is effective in reducing noise inside a vehicle and improving processability by preventing reduction of sound absorbing performance while significantly reducing weight.

The sound absorbing material of the present invention does not use a heavy sound insulating sheet, which takes up 80% of the total weight, but uses a double layer having the structure of “hard sound absorbing material layer+soft sound absorbing material layer” at the portion requiring vibration control and low frequency sound absorbing and insulating performance and uses only the soft sound absorbing material layer at the portion requiring high frequency sound absorbing and insulating performance. The resulting partial double-layered sound absorbing structure maximizes the high-frequency sound-absorbing performance.

That is, the sound absorbing material has a double-layered structure of a high density layer and a low density layer. At the portion directly affected by noise, such as near an engine, fan, belt, etc., the high density layer is selectively employed. And, the low density layer is employed at the entire noisy portion. Resultantly, significant improvement in reducing noise inside a vehicle and processability can be achieved with relatively small weight.

Regarding the transmission noise of the engine, high-frequency noise having a frequency of at least 1,000 Hz, especially in the region of 1,000-4,000 Hz is effectively removed. The frequency range of 1,000-4,000 Hz is the region most people can sense most sensitively. Outside this range, the sense of hearing becomes dull. The present invention was evaluated mainly by the sound absorbing performance. Test sample was evaluated with Apamat, a sound absorbing and insulating tester, and α-Cabin, a sound-absorbing performance tester. The evaluation result was analyzed with AutoSEA (Automatic Statistical Energy Analysis), the most reliable vehicle noise and vibration simulation program in Korea. Further, the actual noise inside a vehicle was evaluated. The result shows that the sound absorbing material has better sound absorbing and insulating performance while reducing as much as 60% of weight.

Hereinafter, the sound absorbing material of the present invention for a dash inner is described in more detail.

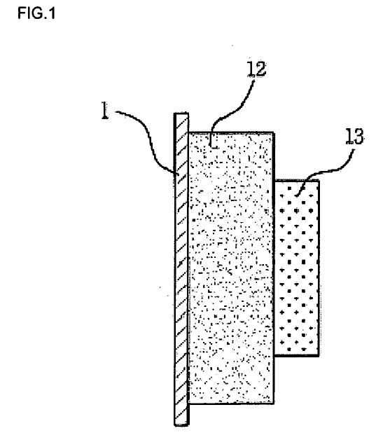

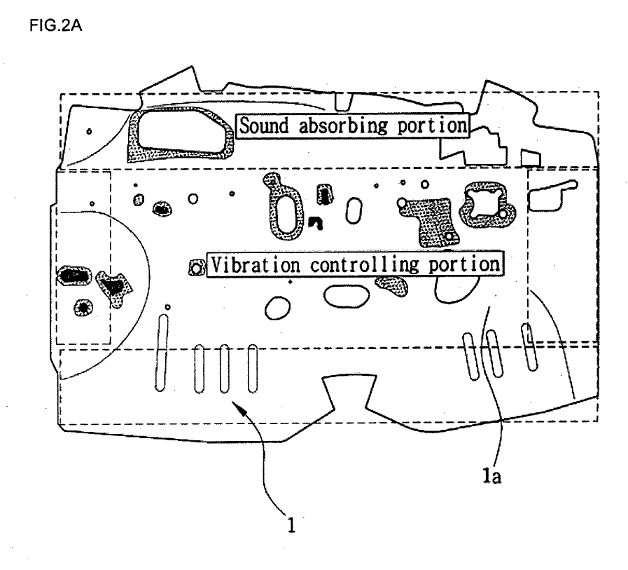

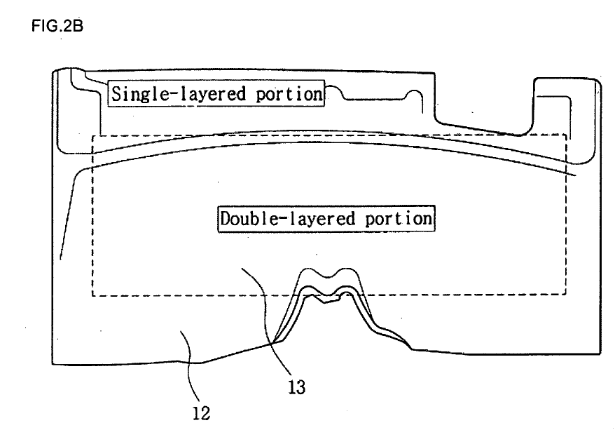

As illustrated in FIG. 1, the sound absorbing material of the present invention for dash panel 11 comprises low density material layer (soft felt layer) 12 and high density material layer (hard felt layer) 13. The sound absorbing material has a double-layered structure only at the center portion requiring good vibration control and low frequency sound absorbing and insulating performance. That is, the high density material 13 is laminated at the center portion to form a double layer and the other portion comprises only low density material 12 (see FIG. 2b). In FIG. 2a, center portion 1a of dash panel 1 is directly affected by the noise generated by an engine. Further, because a fan, a belt, etc. are also located at the portion, vibration control and low frequency sound absorbing and insulating performance at this portion is very important. Thus, the center portion of the sound absorbing material corresponding to center portion la is constructed in a double-layered structure, and the other portion is constructed in a single-layered structure. Because air conditioner hoses, acceleration pedal cables, etc. pass through center portion 1a of dash panel 1, vibration is transferred to the portion. Thus, the sound absorbing material at center portion 1a is constructed in a double-layered structure of “soft felt layer+hard felt layer” to improve low frequency (500 Hz or below) vibration control and sound-absorbing performance. Other portions excluding center portion 1a is constructed in a single layer of a soft felt layer to maximize sound-absorbing performance in the high frequency region of 500 Hz or above and improve the engine sound. The sound absorbing material of the present invention absorbs noise leaked via holes and is capable of maximizing vibration control and sound-absorbing performance of a dash panel.

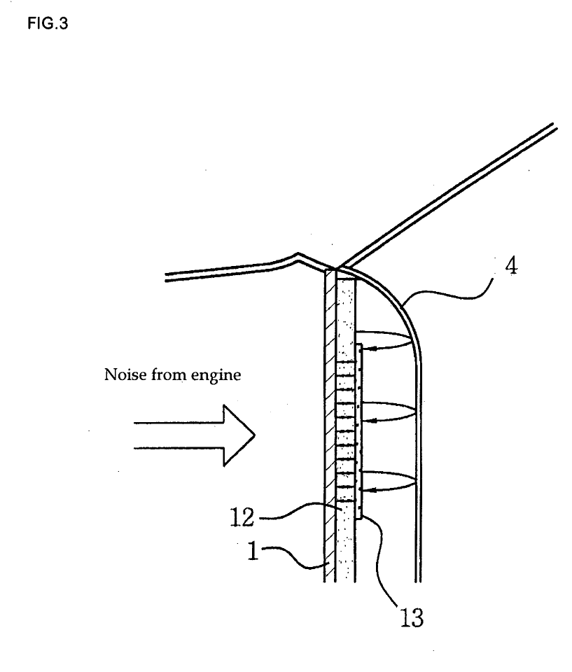

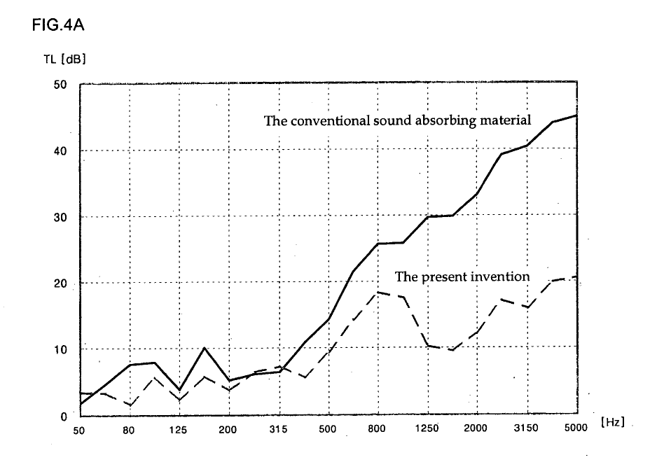

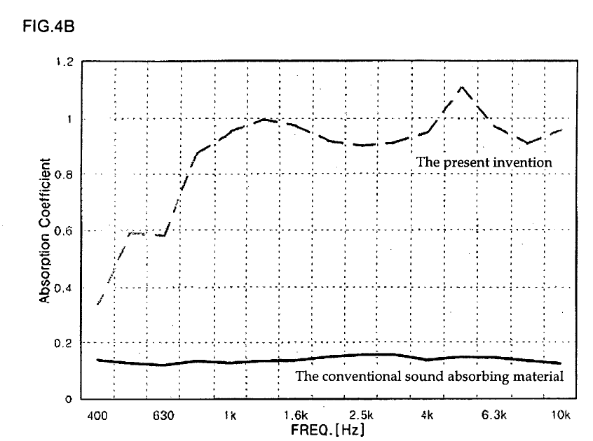

This partial double-layered sound absorbing structure is effective in improving sound absorbing and insulating effect. As in the present invention, if a double-layered sound absorbing material comprising only fiber material is employed, the noise generated from an engine passes via dash panel 11 and is transferred to the sound absorbing material portion after being reflected at crash pad 4 (see FIG. 3). As the noise is absorbed by the sound absorbing material, most of high-frequency sound of 1,000 Hz or above is absorbed and a sound having a pleasant sound quality is transferred into the vehicle (see FIG. 4b).

Comparison test was performed for the sound absorbing material of the present invention and the conventional sound absorbing and insulating material having the structure of “heavy layer sound insulating sheet+polyurethane (PU)”. The result is shown in FIG. 4a and FIG. 4b. The sound absorbing and insulating performance was evaluated with Apamat and α-Cabin. Noise inside a vehicle was evaluated using AutoSEA, a simulation program for analyzing noise and vibration. The sound absorbing material of the present invention was confirmed to be superior to the conventional one.

More particularly, the hard layer (high density material) of the sound absorbing material of the present invention has a surface density of 500-2,000 g/m². Because it is heavy for its thickness, its surface becomes rather hard. To improve vibration control of solid borne sound and low frequency (500 Hz or lower) sound absorbing and insulating performance, needle type PET may be used instead of the conventional layer type PET. The composition is 30 wt % of LM (low melt)-PET 4De′+70 wt % of R (regular)-PET 6De′.

The soft layer has a surface density of 500-2,000 g/m². The content of low denier was increased than that of the conventional DASH ISO-PAD to maximize high frequency (500 Hz or above) sound-absorbing performance. The composition is 30 wt % of LM-PET 4De′+50 wt % of R-PET 3De′+20 wt % of R-PET 6De′.

The sound absorbing material of the present invention has a partial double-layered sound absorbing structure. Major noise source is analyzed by evaluating sound pressure distribution of each portion for each frequency region when the transmission noise generated by an engine passes through the dash panel. From the analysis, the double-layered sound absorbing structure is applied to the portion of the dash panel requiring superior vibration control and low frequency sound absorbing and insulating performance. Besides, only the soft layer sound absorbing material is applied to the portion requiring superior high frequency sound absorbing and insulating performance only. Preferably, the area of the hard, high density sound absorbing material layer is set to comprise 20-90% of that of the soft, low density sound absorbing material layer in the manufacturing process. Then, superior sound absorbing and insulating performance can be obtained while reducing weight. Preferably, the area of the high density sound absorbing material layer is set to comprise 30-80% of that of the low density sound absorbing material layer. Most preferably, the area of the high density sound absorbing material layer is set to comprise 40-60% of that of the low density sound absorbing material layer.

If the area of the high density material layer is smaller than 20% of the area of the low density material layer, the sound absorbing and insulating performance worsens significantly. In contrast, if it exceeds 90% of the area of the low density material layer, the surface becomes too hard, so that it is disadvantageous in terms of transfer, installation and weight reduction.

For large luxury vehicles, a nonwoven fabric may be inserted between the soft felt layer and the hard felt layer to offer better sound quality tuning. It may contribute to improving low frequency sound absorbing and insulating performance.

Hereinafter, the present invention is described in more detail through examples. However, the following examples are only for the understanding of the present invention and they should not be construed as limiting the scope the present invention.

### EXAMPLES AND COMPARATIVE EXAMPLES

30 wt % of 4-denier sheath-core type polyester fiber having a melting point of 120 □ and a length of 51 mm and 70 wt % of 6-denier polyester staple fiber having a melting point of 255 □ and a length of 51 mm were woven to a high density layer sound absorbing material having a thickness of 5 mm and a surface density of 800 g/m² by needle punching. 30 wt % of 4-denier sheath-core type polyester fiber having a melting point of 120 □ and a length of 51 mm, 50 wt % 3-denier polyester staple fiber having a melting point of 255 □ and a length of 51 mm and 20 wt % of 6-denier polyester staple fiber having a melting point of 255 □ and a length of 51 mm were woven to a low density layer sound absorbing material having a thickness of 15 mm and a surface density of 1,200 g/m².

The low density sound absorbing material and the high density sound absorbing material were laminated. Sound absorbing and insulating performance was evaluated using Apamat and α-Cabin. Noise simulation inside a vehicle was performed using AutoSEA. The result is presented in Table 2 below. Actual product that can be installed in a vehicle was manufactured and test was performed. The high density sound absorbing material was processed first using a preheating oven and a foaming mold as presented in Table 1. Then, the low density sound absorbing material was placed on the first layer and pressed to bond them. The resultant sound absorbing material was installed in an actual vehicle and test was performed. The result is presented in Table 2 below.

TABLE 1

| | | | | Sound absorbing material | | | | |
|---|---|---|---|---|---|---|---|---|
| | | | Sound | Second layer | | First layer | | Proportion |
| | Properties | | insulating | | Surface | | Surface | of |
| | Weight | Thickness | material | Thickness | density | Thickness | density | second |
| Category | (kg/m²) | (mm) | (g/m²) | (mm) | (g/m²) | (mm) | (g/m²) | layer (%) |
| Example 1 | 1.60 | 20 | — | 5 | 800 | 15 | 1,200 | 50 |
| Example 2 | 1.92 | 20 | — | 5 | 800 | 15 | 1,200 | 90 |
| Example 3 | 1.84 | 20 | — | 5 | 800 | 15 | 1,200 | 80 |
| Example 4 | 1.76 | 20 | — | 5 | 800 | 15 | 1,200 | 70 |
| Example 5 | 1.68 | 20 | — | 5 | 800 | 15 | 1,200 | 60 |
| Example 6 | 1.52 | 20 | — | 5 | 800 | 15 | 1,200 | 40 |
| Example 7 | 1.44 | 20 | — | 5 | 800 | 15 | 1,200 | 30 |
| Example 8 | 1.36 | 20 | — | 5 | 800 | 15 | 1,200 | 20 |
| Comparative | 2.0 | 20 | — | 5 | 800 | 15 | 1,200 | 100 |
| Example 1 | | | | | | | | |
| Comparative | 1.28 | 20 | — | 5 | 800 | 15 | 1,200 | 10 |
| Example 2 | | | | | | | | |
| Comparative | 5.7 | 20 | EVA 2T | 18 | 1,700 | — | — | — |
| Example 3 | | | (4000) | | | | | |

TABLE 2

| | | | | | Weight |
|---|---|---|---|---|---|
| | Total | SEA | | | reduc- |
| | weight | simulation | Actual noise test result | | tion |
| Category | (kg/ea) | result | O/A (dBA) | AI (%) | (kg/ea) |
| Example 1 | 2.0 | Superior | Superior | Superior | −4.5 |
| Example 2 | 2.4 | Superior | Superior | Superior | −4.1 |
| Example 3 | 2.3 | Superior | Superior | Superior | −4.2 |
| Example 4 | 2.2 | Superior | Superior | Superior | −4.3 |
| Example 5 | 2.1 | Superior | Comparable | Superior | −4.4 |
| Example 6 | 1.9 | Comparable | Comparable | Comparable | −4.6 |
| Example 7 | 1.8 | Comparable | Comparable | Comparable | −4.7 |
| Example 8 | 1.7 | Comparable | Comparable | Comparable | −4.8 |
| Compar- | 2.5 | Superior | Superior | Superior | — |
| ative | | | | | |
| Example 1 | | | | | |
| Compar- | 1.6 | Inferior | Inferior | Inferior | −4.9 |
| ative | | | | | |
| Example 2 | | | | | |
| Compar- | 6.5 | Standard | Standard | Standard | — |
| ative | | | | | |
| Example 3 | | | | | |

In Examples 1-8, all the conditions excluding the proportion of the area of the high density sound absorbing material to the low density sound absorbing material are equal. In Comparative Example 1, the area of the high density sound absorbing material layer was set to comprise 100% of that of the low density sound absorbing material layer (all surface is with a double-layered structure). In Comparative Example 2, the area of the high density sound absorbing material layer was set to comprise 10% of that of the low density sound absorbing material layer. In Comparative Example 3, an EVA layer was added and polyurethane foam was used as the sound absorbing material. In the actual noise test, a product formed by foaming urethane in the EVA layer was used. The sound-absorbing performance was tested using reverberation chamber devices. A sound absorbing material having an area of 0.7-1.44 m² was put in a miniature reverberation chamber. Sound absorption of the sound absorbing material was tested as sound reflected at the chamber to the material.

As seen in Table 2, the sound absorbing materials of Examples showed weight reduction

and 90-100% of sound absorbing and insulating performance, compared with Comparative Example 1. Especially, they showed improvement in sound quality. The sound absorbing materials of Examples are considered to be advantageous in transfer, installation and processing because of the partial double-layered structure. Comparative Example 2 showed the worst result. The sound absorbing materials of Examples showed comparable or superior performance, compared with Comparative Example 3, even with significantly reduced total weight.

As apparent from the above description, the sound absorbing material for a vehicle the present invention significantly contributes to reduction of weight. Thus, it contributes to improvement in fuel efficiency, transfer, installation and processing. Also, because it is made of recyclable material, it contributes to reducing environmental pollution.

While the present invention has been described in detail with reference to the preferred embodiments, those skilled in the art will appreciate that various modifications and substitutions can be made thereto without departing from the spirit and scope of the present invention as set forth in the appended claims.

1. A sound absorbing material for a vehicle comprising at least two layers of a low density sound absorbing material having a relatively low surface density and a high density sound absorbing material having a relatively high surface density, wherein the high density sound absorbing material is positioned within said material corresponding vehicle locations requiring a higher level of vibration control and low frequency sound absorbing and insulating performance and wherein other portions comprise only the low density sound absorbing material.

2. The sound absorbing material of claim 1, wherein the high density sound absorbing material is positioned at the center of the sound absorbing material opposing the center portion of a dash panel.

3. The sound absorbing material of claim 1, wherein a nonwoven fabric is additionally inserted between the high density sound absorbing material and the low density sound absorbing material.

4. The sound absorbing material of claim 1, wherein the high density sound absorbing material has a surface density of 500-2,000 g/m² and the low density sound absorbing material has a surface density 500-2,000 g/m².

5. The sound absorbing material of claim 1, wherein the lamination area of the high density sound absorbing material comprises 20-90% of the area of the low density sound absorbing material.

6. The sound absorbing material of claim 5, wherein the lamination area of the high density sound absorbing material comprises 30-80% of the area of the low density sound absorbing material.

7. The sound absorbing material of claim 5, wherein the lamination area of the high density sound absorbing material comprises 40-60% of the area of the low density sound absorbing material.

8. The sound absorbing material of claim 2, wherein the lamination area of the high density sound absorbing material comprises 20-90% of the area of the low density sound absorbing material.

9. The sound absorbing material of claim 8, wherein the lamination area of the high density sound absorbing material comprises 30-80% of the area of the low density sound absorbing material.

10. The sound absorbing material of claim 8, wherein the lamination area of the high density sound absorbing material comprises 40-60% of the area of the low density sound absorbing material.

11. The sound absorbing material of claim 3, wherein the lamination area of the high density sound absorbing material comprises 20-90% of the area of the low density sound absorbing material.

12. The sound absorbing material of claim 11, wherein the lamination area of the high density sound absorbing material comprises 30-80% of the area of the low density sound absorbing material.

13. The sound absorbing material of claim 11, wherein the lamination area of the high density sound absorbing material comprises 40-60% of the area of the low density sound absorbing material.

14. The sound absorbing material of claim 4, wherein the lamination area of the high density sound absorbing material comprises 20-90% of the area of the low density sound absorbing material.

15. The sound absorbing material of claim 14, wherein the lamination area of the high density sound absorbing material comprises 30-80% of the area of the low density sound absorbing material.

16. The sound absorbing material of claim 14, wherein the lamination area of the high density sound absorbing material comprises 40-60% of the area of the low density sound absorbing material.
